(19) United States
(12) Patent Application Publication
(10) Pub. No.: US 2007/0133876 A1
(43) Pub. Date: Jun. 14, 2007

(54) Device, method, and computer program product for enhancing the use of electronic forms in mobile devices

(75) Inventors: Suresh Chande, (US); Kimmo Ramo, (US); Saarinen Petteri, (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 11/302,802

(22) Filed: Dec. 14, 2005

(51) Int. Cl. G06K 9/00; G06K 9/46; G06F 17/00

(52) U.S. Cl. 382/181; 715/505; 715/507; 382/190

(57) ABSTRACT

A device, method, and computer program product enhance the use of electronic forms in mobile devices, such as by using a camera image for entering data into an input field of an electronic form. A portion of the camera image may be captured and displayed in the input field of the form. Data from the camera image may be extracted and embedded in the input field. In this regard, a device for using a camera image to enter data in a form comprises a camera element, a display element and a processing element. The camera element may be capable of capturing an image. The processing element may be capable of displaying a form and displaying at least a portion of the image in an input field of the form, and further capable of extracting a data item from the image and embedding the extracted data item in the input field.

### FIELD OF THE INVENTION

Embodiments of the invention generally relate to mobile devices and, more particularly, relate to the use of electronic forms in mobile devices.

### BACKGROUND OF THE INVENTION

Electronic forms are commonly used for presenting information in a defined and structured manner, as well as extracting information from users in a similarly defined and structured manner. Forms provide an interface between users and computer applications. The use of forms helps ensure that data is entered accurately and completely.

Data is often entered by users into electronic forms via a personal computer interfacing with a client-server application over a network, such as the Internet or a dedicated network. Data entry into forms via a personal computer is generally easy and convenient due to the various user interface options available on a personal computer, such as a full-size QWERTY keyboard and a pointing device such as a mouse.

The increasing use of mobile communication and organization devices, such as mobile phones, personal digital assistants (PDAs), and handheld computers, has prompted a corresponding increase in software applications that enable users of such devices to accomplish many tasks that previously required access to a personal computer or even paper forms. For example, a sales person may use such a mobile device to transmit customer orders to the company's central order processing system. Similarly, an insurance adjuster may use such a mobile device to transmit damage reports to the insurance company's central claims processing system. Such software applications often use electronic forms to facilitate the entry of the appropriate data in the appropriate format. A mobile device and method for using electronic forms is described in U.S. patent application Ser. No. 10/978,088 entitled, “Electronic Equipment and Method for Carrying Out Communication with Electronic Equipment,” filed Oct. 28, 2004, the contents of which are incorporated herein in its entirety.

While such software applications used in conjunction with mobile devices may enable a user to conduct many activities while traveling, such mobile devices generally have user interfaces that are smaller and which may have less functionality than the user interfaces of personal computers. Entering data in electronic forms using such mobile devices may be somewhat cumbersome. As such, there is a need for an improved device, method, and computer program product for using electronic forms.

Extensible Markup Language (XML) based applications are commonly used to receive and display information on a mobile communication and organization device. Some examples of XML-based applications include RSS applications (which variously stands for Rich Site Summary, RDF Site Summary, and Really Simple Syndication), FLASH™ applications, scalable vector graphics (SVG) applications, extensible hypertext markup language (XHTML) applications, and mApache (i.e., a web server executing locally in a mobile device) applications. While these applications are XML-based, each of these applications may have unique schema which define the structure and content required to render application data in each particular application. Creating the documents to render the application data for any particular XML-based application typically requires some amount of programming skill and experience, whether the XML document is directly created, created using an application specific tool, or created using some other known method of creating XML documents. As a result, there is a need for an improved device, method, and computer program product for creating application-specific XML-based documents to enable users to quickly and easily create such documents will little or no programming experience.

Message-based services are increasingly used for many different enterprise and consumer applications. For example, a consumer may use a message-based service to obtain a telephone number from a telephone directory or to obtain a bus schedule. A business employee may use a message-based service to book a conference room or a teleconferencing line. Such services are typically invoked by sending a text message from a mobile device, such as a mobile telephone, to a network entity, such as a server. The text messages must typically be created using a predefined format, which typically includes presenting predefined information in a predefined order, such that the service request will typically fail or return incorrect information if the format is not precisely followed. For example, a message-based service capable of providing a telephone number may require that the user send a text message having the format: <LastName>, <FirstName>: <City>, <State>. The text messages must typically be transmitted to a service provider via a predefined messaging protocol, such as email, short messaging service (SMS) protocol, multimedia messaging service (MMS) protocol, or messaging queue (MQ) protocol. The text messages must typically be transmitted using a predefined communication identifier, such as a telephone number, an SMS address, or an email address. The user typically needs to remember the correct format and communication identifier in order to send a successful service request message. In addition to the difficulty of remembering the correct message format and communication identifier, the user interface of the mobile devices that may be used to send such service request messages may be somewhat cumbersome, as discussed above, thereby causing difficulty in correctly entering the predefined information and the predefined communication identifier. As such, there is a need for an improved device, system, method, and computer program product for generating a request for a message-based service.

Microprocessor-based devices, such as personal computers, laptop computers, mobile phones, PDAs, and handheld computers, are typically able to execute many different software applications. Some of these software applications execute in a standalone manner, in that these applications typically are not able to communicate with devices or software applications external to the device upon which the standalone application is executing. As such, these applications may be termed “standalone applications.” Others of these software applications are capable of communicating with devices or software applications external to the device upon which the application is executing, in order to send or receive information or instructions. As such, these applications may be termed “connected applications.” As a group, the standalone applications and the connected applications executing on a device may be termed “core” or “native” applications.

A third-party provider of services, such as Web services that are offered via the Internet, may desire to develop and offer services that interface with and utilize one or more native applications to provide new functionality to users of such devices. However, developing services to work with these native applications can be difficult. For example, there may be no standard protocol for communicating with the standalone applications. Additionally, the connected applications typically have an application-specific interface. As such, there is a need for an improved device, system, method, and computer program product for providing new functionality for native applications.

### BRIEF SUMMARY OF THE INVENTION

A device, method, and computer program product are therefore provided in which data can be entered into an input field of an electronic form using a camera image. A portion of the camera image may be captured and displayed in the input field of the form. Data from the camera image may then be extracted and embedded in the input field.

In this regard, a device for using a camera image to enter data in a form comprises a camera element, a display element and a processing element. The camera element may be capable of capturing an image. The processing element may be capable of displaying a form and displaying at least a portion of the image in an input field of the form. The processing element may be further capable of extracting a data item from the image and embedding the extracted data item in the input field.

The processing element may be further capable of identifying a data type of the input field and extracting a data item from the image that has a data type corresponding to the data type of the input field. The data type may be selected from the group comprising text, audio, image, bar code, color, telephone number, uniform resource locator, and email address.

In one embodiment, the device further comprises a storage element containing a database of data types and corresponding image patterns. The processing element may be further capable of comparing the captured image to an image pattern having a data type corresponding to the data type of the input field.

The processing element may be capable of displaying a portion of the image having a size and shape relationship to the image that corresponds to a size and shape relationship between the input field and the form.

In one embodiment, the processing element is further capable of extracting two or more data items from the image and displaying the extracted data items such that a user may select one of the displayed data items. The processing element may be further capable of embedding the selected data item in the input field.

In addition to the device for using a camera image to enter data in a form described above, other aspects of the invention are directed to corresponding methods and computer program products for using a camera image to enter data in a form.

Additionally, a device, method, and computer program product are provided in which a plurality of application-specific and task-specific templates are provided for creating an application specific markup language document. When a template is selected by a user, one or more predefined forms are rendered in a predefined order, with each form typically providing information to the user, obtaining data from the user, or both. Each template typically contains a predefined markup language structure that is application-specific and task-specific. The markup language structure is modified according to the user-provided data, thus creating the markup language document comprising the desired application data. After the markup language document is created, the application data may be rendered by the appropriate markup language-based application.

In this regard, a device for creating an application-specific markup language document comprises a processing element capable of accessing a template, the template comprising a predefined markup language structure and a plurality of predefined forms. The processing element may be further capable of rendering in a predefined order the plurality of predefined forms, and receiving data from a user in response to the rendering of at least one of the forms. The processing element may be further capable of modifying the predefined markup language structure in response to the received data to create the application-specific markup language document. In one embodiment, the application-specific markup language document is an extensible markup language (XML) document and the predefined markup language structure is a predefined XML structure.

The application-specific markup language document may be capable of being accessed by one of an RSS application, a FLASH application, a scalable vector graphics application, a hypertext markup language application, and a mApache application.

In one embodiment, the device further comprises a storage element capable of storing a plurality of templates, each template comprising a predefined markup language structure and a plurality of predefined forms. In such an embodiment, the processing element may be further capable of accessing a template in response to a user selection of one of the plurality of stored templates.

In addition to the device for creating an application-specific markup language document described above, other aspects of the invention are directed to corresponding methods and computer program products for creating an application-specific markup language document.

Additionally, a device, system, method, and computer program product are provided in which a service request message may be generated based on user input to a service request form. The service request form prompts the user to input the information needed to generate a request for a desired service. A properly formatted service request message is then generated according to the requirements of the service provider. The service request message is then transmitted to the service provider using a predefined communication identifier.

In this regard, a device for requesting a message-based service comprises a display element and a processing element. The processing element may be capable of rendering a service request form on the display element. The processing element may be further capable of receiving at least one user input in response to the service request form. The processing element may be further capable of generating a service request message incorporating the user input and transmitting the service request message to a predefined service provider using a predefined communication identifier, the service request message conforming to a predefined messaging protocol. The predefined messaging protocol may be selected from the group consisting of an email protocol, a short messaging service (SMS) protocol, a multimedia messaging service (MMS) protocol, and a messaging queue (MQ) protocol.

In one embodiment, the processing element is further capable of displaying a list of available service request forms and receiving a user selection of one of the available service request forms, such that the processing element renders the user selected service request form. Additionally, the processing element may be further capable of receiving a service acknowledgment message and rendering on the display element a service acknowledgment form corresponding to the service acknowledgment message.

The processing element may be further capable of determining if an updated version of the service request form is available and receiving the available updated version such that the processing element renders the updated version of the service request form.

In addition to the device for requesting a message-based service described above, other aspects of the invention are directed to corresponding systems, methods, and computer program products for requesting a message-based service.

Additionally, a device, system, method, and computer program product are provided in which one or more native applications may be interfaced with and utilized to provide additional functionality. An application-specific and task-specific form may be executed to create a markup language document, such as an XML document. Executing a form typically entails interpreting and rendering the form via a user interface (Ul), as well as incorporating any user interaction into the form. The XML document may be used to generate a software call to a native software application to invoke the functionality of the native software application.

In this regard, a device for interfacing with a native software application comprises a processing element capable of accessing and executing a form, and then generating a markup language document in response to the execution of the form. The processing element is further capable of generating a software call for the native software application from at least a portion of the markup language document. The processing element further capable of providing the software call to the native software application. The markup language document may be generated using an extensible markup language.

In one embodiment, the device further comprises a user input element. The processing element may be further capable of receiving user input from the user input element and generating the markup language document further in response to the received user input. The device may further comprise a display element, and the processing element may be further capable of displaying information on the display element in response to the execution of the form. The device may further comprise a storage element, and the processing element may be further capable of storing information in the storage element in response to the execution of the form.

The processing element may be further capable of receiving an output from the native software application, accessing the stored information in response to the received output, and generating a second software call for a second native software application in response to the received output.

In addition to the device for interfacing with a native software application described above, other aspects of the invention are directed to corresponding systems, methods, and computer program products for interfacing with a native software application.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a functional block diagram of a device for using a camera image to enter data in a form, according to an exemplary embodiment of the invention;

FIG. 2 is a flowchart of the operation of using a camera image to enter data in a form, according to an exemplary embodiment of the invention;

FIG. 3 illustrates the operation of using a camera image to enter data in a form, according to an exemplary embodiment of the invention;

FIG. 4 is a functional block diagram of a device for creating an application-specific XML document, according to an exemplary embodiment of the invention;

FIG. 5 illustrates an XML template, according to an exemplary embodiment of the invention;

FIG. 6 is a flowchart of the operation of creating an application-specific XML document, according to an exemplary embodiment of the invention;

FIG. 7 is a functional block diagram of a device for requesting a message-based service, according to an exemplary embodiment of the invention;

FIG. 8 illustrates a service request form, according to an exemplary embodiment of the invention;

FIG. 9 is a flowchart of the operation of requesting a message-based service, according to an exemplary embodiment of the invention;

FIGS. 10A and 10B are functional block diagrams of a system for requesting a message-based service, according to exemplary embodiments of the invention;

FIG. 11 is a functional block diagram of a device for interfacing with a native software application, according to an exemplary embodiment of the invention;

FIG. 12 is a flowchart of the operation of interfacing with a native software application, according to an exemplary embodiment of the invention; and

FIGS. 13A and 13B illustrate forms capable of implementing new functionality for native software applications, according to exemplary embodiments of the invention.

### DETAILED DESCRIPTION OF THE INVENTION

Embodiments of the invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention are herein described in terms of mobile devices capable of performing the specified functions. It should be understood, however, that the mobile devices illustrated and hereinafter described are merely illustrative of the types of mobile devices that would benefit from embodiments of the invention and, therefore, should not be taken to limit the scope of embodiments of the invention. Many types of mobile stations, such as mobile telephones, portable digital assistants (PDAs), two-way pagers, laptop computers, handheld computers, and other types of electronic systems, can readily employ embodiments of the invention. Additionally, it should be appreciated that devices other than mobile devices, such as personal computers, can readily employ embodiments of the invention.

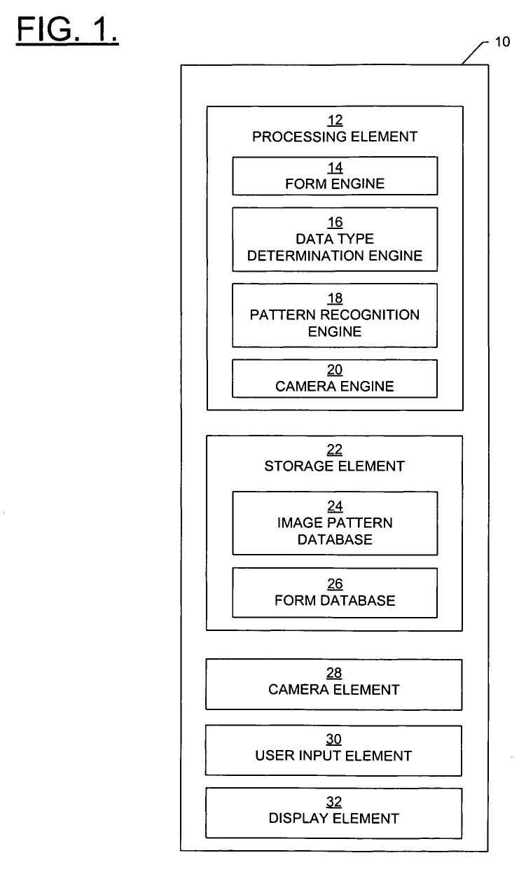

FIG. 1 is a functional block diagram of a device capable of using a camera image to enter data in a form, according to an exemplary embodiment of the invention. The device 10 of FIG. 1 may be, for example, a mobile phone, a personal digital assistant (PDA), a handheld computer, or any other suitable mobile device having a digital camera element. Typically, the digital camera element is integral, although the camera element could be otherwise in communication with the device 10 if desired. The device 10 comprises a processing element 12, a storage element 22, a camera element 28, a user input element 30, and a display element 32. The processing element may comprise a form engine 14, a data type determination engine 16, a pattern recognition engine 18, and a camera engine 20. The storage element may contain a form database 26 and an image pattern database 24.

The device 10 may be used to complete (i.e., “fill in”) an electronic form. Such forms are often used to record and transfer information, such as customer orders from a sales person and damage reports from an insurance claims adjuster, as discussed above. The information is typically entered into one or more input fields in the form, with each input field typically corresponding to one or more desired data items. Each input field will typically have a corresponding label to indicate to the user the data that is to be entered into each input field. Embodiments of the invention enable a user of the device to enter data into an input field by using the camera element 28 to capture an image of an object that corresponds to or contains the desired data, such that the data may be extracted from the image and embedded in the input field. To facilitate the image capture of the appropriate object and therefore the entry of the appropriate data into the appropriate input field, at least as portion of the camera image may be displayed in the input field of the form. This makes it appear as if the input field is transparent and the user is able to look through the input field at the object in the camera element's field of view. The object may be, for example, a business card, newspaper, label, or any other object containing text that may be captured. The object may be some other physical object, such that an attribute of the object (e.g., color, shape, size) may be extracted.

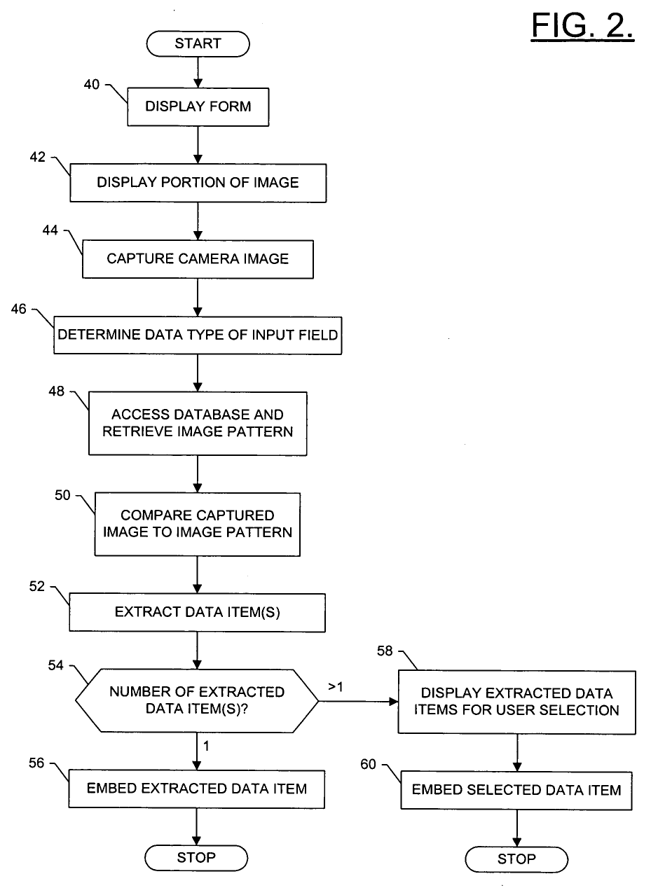

Referring to both FIG. 1 and FIG. 2, the operation of using a camera image to enter data in a form will be described, according to an exemplary embodiment of the invention. The user will typically begin by selecting an electronic form (e.g., from a menu of forms) that is then displayed on the display element 32 of the device. See block 40 of FIG. 2. A number of different forms may be stored in the form database 26 of the storage element 22. The storage, organization, and display of the forms may be controlled by the form engine 14. The user will typically select the form that corresponds to the information the user desires to record and transmit. Although not illustrated in FIG. 2, the form engine may determine whether a newer or updated version of the selected form is available. Each form may have a version and/or a date code. The form engine may communicate with the provider of the form to determine the version and/or date of the form currently available from the form provider, and then compare that version and/or date to the version and/or date of the form currently stored on the device. If an updated form is available, the form engine may request and receive the updated form from the form provider. The form engine would also typically store the updated form so that the updated form is available for future use. Alternatively, the provider of the form may send an updated form to the device when changes are made or a new version is available. This would typically require that the provider of the form be able to store information to track which devices have received which forms, which would typically be tracked from the time each form is first received by a device. The provider would also typically store information to track how updated forms can be sent to each device (e.g., the MMS, email or IP address of the device).

As discussed above, the form will typically comprise a number of input fields with corresponding field names. Some of the input fields may be automatically populated with data, such as by the form engine 14. For example, the user's name and the current date and time may be automatically populated in the appropriate input fields. Other input fields will generally require the user to input data to complete the form. For some fields, the user may manually input the necessary data, such as by using a user input element 30 (e.g., an alphanumeric keypad) to type in the data. For other fields, it may be too cumbersome or slow to use the user input element. As such, the user may choose to use the camera element to enter the data. The user would typically select the desired input field, such as by scrolling to the field, and select an option to enter data using the camera element. The form engine 14 will then typically receive the camera image via the camera engine 20 and display all or a portion of the camera image in the input field. The user may then look at the input field on the display element and point the camera element at an object containing or corresponding to the desired data. The user would then typically see whatever is in the camera element's field of view (i.e., whatever the camera element is pointed at) displayed in the input field. See block 42 of FIG. 2. The user may move the device (and therefore the camera element) and/or may zoom the camera element in or out until the desired data is displayed in the input field. The entire camera image may be displayed in the input field, or only a portion of the image having the same size and shape as the input field may be displayed. Displaying only a portion of the camera image may enable the camera element to work faster and may reduce overall processing and power consumption, thereby extending battery life of the device.

When the object (or portion thereof) that contains the desired data is displayed in the input field, the user will typically then cause the camera engine to capture a digital image of the object, such as by pressing a button on the device 10. See block 44 of FIG. 2. Each input field will typically have a data type that indicates what kind of data should be entered into the input field. The data type may be relatively broad (e.g., text, image) or relatively narrow (telephone number, uniform resource locator, and email address, color, facial image). The data type determination element 16 will typically determine the data type of the input field from the form engine. See block 46 of FIG. 2. The data type determination element will then typically retrieve an image pattern having the same data type from the image pattern database 24. See block 48 of FIG. 2. The image pattern database typically contains predefined examples of images (i.e., image patterns) which correspond respectively to each of the different data types to facilitate the extraction of the appropriate data from the camera image. Thus the image pattern provides context to the pattern recognition engine to improve recognition and extraction of the data from the image. The data type determination element will then typically provide the image pattern to the pattern recognition engine 18. The pattern recognition engine will typically compare the camera image to the image pattern. See block 50 of FIG. 2. The pattern recognition engine will then typically identify and extract the data that is similar to the image pattern from the camera image. See block 52 of FIG. 2. The pattern recognition engine may have, for example, optical character recognition (OCR) capability, color recognition capability, facial recognition capability, and bar code recognition capability.

It is possible that the pattern recognition engine may identify and extract more than one data item from the camera image that has the desired data type. For example, the user may be attempting to input a telephone number into a form using a camera image. Such an input field would typically have a data type of a telephone number, and the image pattern would typically comprise ten numbers having a typical telephone number format (e.g., “(000)000-0000,” “000-000-0000,” or “000.000.0000”). The user may capture the image of a business card containing the desired telephone number. However, the business card may contain two or more telephone numbers (e.g., a business number, a fax number, and a mobile number). The pattern recognition engine may identify and extract all of the numbers on the business card. In one embodiment of the invention, the processing element 12 may determine how many data items were extracted. See block 54 of FIG. 2. If only one data item was extracted, the form engine may embed the extracted data item in the input field. See block 56 of FIG. 2. If more than one data item was extracted, the processing element may display all of the extracted data items and enable the user to select the one data item to be embedded. See block 58 of FIG. 2. The form engine may then embed the selected data item in the input field. See block 60 of FIG. 2.

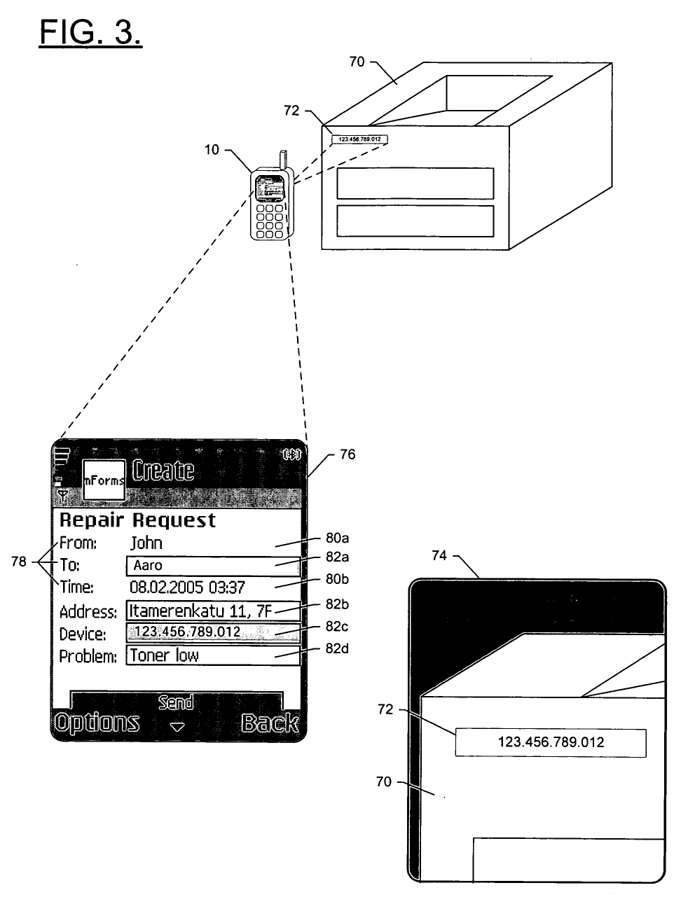

Referring now to FIG. 3, the operation of using a camera image to enter data in a form is further illustrated, according to an exemplary embodiment of the invention. FIG. 3 illustrates the operation of entering data in a form that is used to request service for a printer 70. The service request form 76 is displayed on the display screen (which is enlarged in FIG. 3 for illustration purposes) of the device 10 (a mobile telephone in this illustration). The form 76 comprises several input fields 80a, 80b, 82a, 82b, 82c, 82d. The input fields have field names 78 to inform the user what type of information is required. Two of the input fields 80a, 80b may be automatically populated with the user's name and the current date and time. The other input fields 82a, 82b, 82c, 82d may require the user to input data. Input field 82c may be used to enter a device identifier, such as a network address of the printer. The user may desire to input the network address into the form using the integrated camera.

The user would typically select input field 82c, such as by scrolling to the field, and select an option to enter data using the camera element. The user may then point the camera element at a label 72 that contains the network address of the printer 70. Screen display 74 illustrates the full camera image that might be displayed if the user was only using the camera element to take a photograph, rather than to enter data into a form. As shown, the label 72 is visible in the camera image, but the label typically need not be the only object visible in the camera image. In this illustration, part of the printer 70 is visible in the camera image. The form engine 14 will typically receive the camera image via the camera engine 20 and display all or a portion of the camera image in the input field. In FIG. 3, the portion of the camera image containing the label is displayed in input field 82c. When the user determines that the desired data is displayed in the input field, the user will typically then cause the camera engine to capture a digital image of the object, such as by pressing a button on the device 10. The data type determination element 16 may then determine the data type of the input field from the form engine, and retrieve an image pattern having the same data type from the image pattern database 24. The pattern recognition engine may then compare the camera image to the image pattern, and identify and extract the network address. The network address may then be embedded in the input field 82c. When all of the input fields are filled in, the user would typically transmit the form to the appropriate recipient. The form may be transmitted via any suitable wireless or wireline communication method.

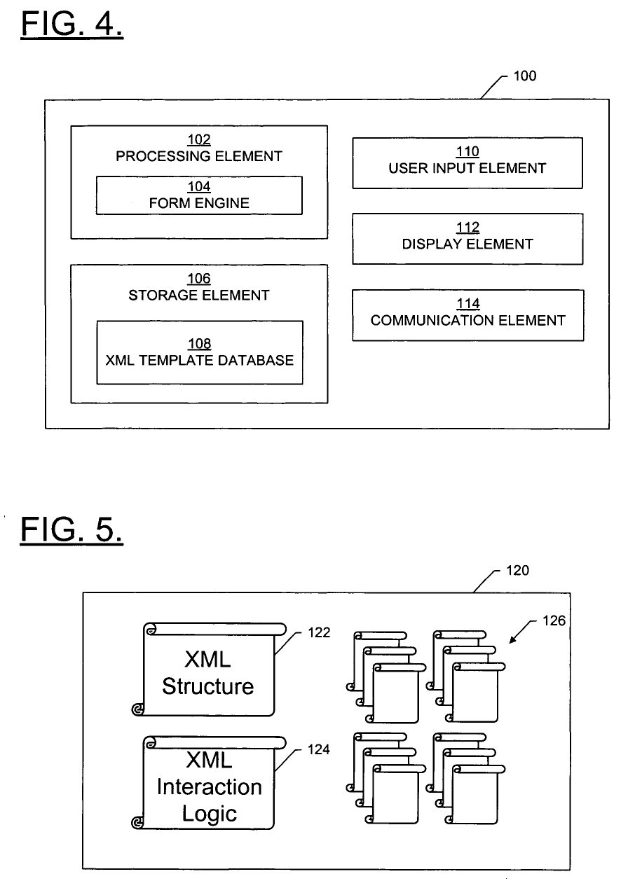

Referring now to FIG. 4, a functional block diagram of a device for creating an application-specific markup language document is illustrated, according to an exemplary embodiment of the invention. For purposes of this illustration, the markup language document and the markup language template will be described as an XML document and an XML template, respectively. It should be appreciated, however, that embodiments of the invention may use documents and templates created using any suitable markup language. The device 100 comprises a processing element 102, a storage element 106, a user input element 110, a display element 112, and a communication element 114. The processing element 102 typically comprises a form engine 104. The form engine generally controls the access of XML templates, the display of electronic forms, the receipt of data from the user, and the creation of the XML document. An XML template database 108, which may contain a plurality of XML templates, may be stored in the storage element 106. Each XML template may enable a user to create an application-specific and task-specific XML document. For example, a user may desire to create an electronic greeting card (this is the specific task) to be rendered using a FLASH application (this is the specific application). As such, an XML template that may be used to create an electronic greeting card to be rendered using a FLASH application may be stored in the XML template database 108.

The form engine may present a list of the available XML templates to the user, such as by displaying the list on the display element 112 of the device 100. The user may select the desired XML template, such as by using the user input element 110. User input element 110 may be, for example, an alphanumeric keypad, such that the user selects the desired XML template by pressing the number key corresponding to the number of the template on the list. Alternative embodiments of the invention may employ any known input element and/or selection technique. The device may further comprise a communication element 114. When the XML document has been created, the XML document may be retained by the device 100 to be rendered by an XML-based application resident on the device. Alternatively, the created XML document may be transmitted, such as by communication element 114 and via a network such as the Internet, to another device to be rendered by an XML-based application resident on the other device. The created XML document may also be transmitted to a server, such that the XML document may be further transmitted to many different devices.

Referring now to FIG. 5, an exemplary structure of an XML template is illustrated, according to an embodiment of the invention. The XML template 120 may comprise an XML structure 122, XML interaction logic 124, and a plurality of electronic forms 126. The XML structure, the XML interaction logic, and the forms in the XML template would typically all be application-specific and task-specific. The XML structure and the XML interaction logic would typically be XML documents. The forms would typically be XML documents with some hypertext markup language (HTML) code to enable the display of the forms. The XML interaction logic typically defines which electronic forms are to be accessed and rendered by the form engine, and in what order, such that the forms 126 are rendered in the order that is predefined by the XML interaction logic. Each form typically provides information to the user, obtains data from the user, or both. As the form engine receives the data from the user in response to each rendered form, the form engine modifies the XML structure, incorporating the user-provided data in a predefined manner. When all of the forms have been rendered according to the XML interaction logic, all of the data has been obtained from the user according to the rendered forms, and all of the modifications to the XML structure have been performed according to the user-provided data, the modified XML structure is the XML document capable of being rendered by the appropriate XML-based application.

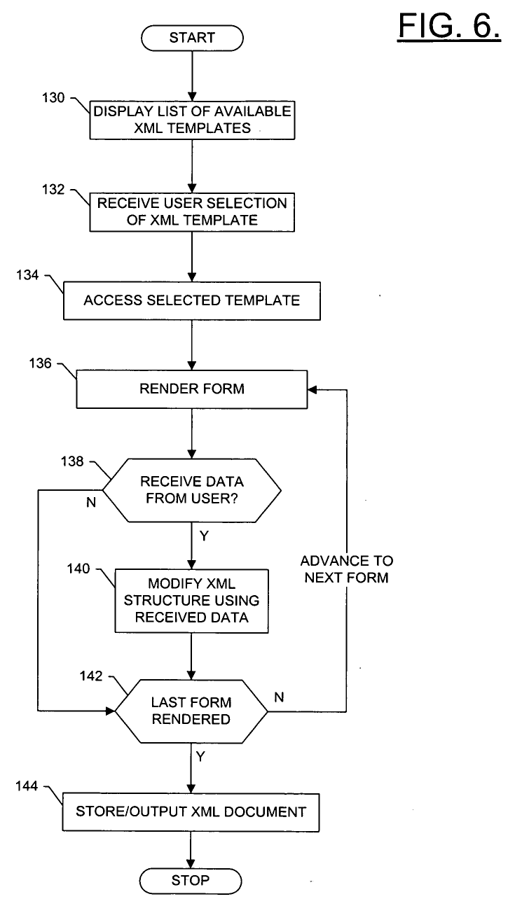

Referring now to FIG. 6, a flowchart of the operation of creating an application-specific XML document is illustrated, according to an exemplary embodiment of the invention. As discussed above, the form engine may present a list of the available XML templates to the user. See block 130. The form engine may receive the user selection of the desired XML template. See block 132. The form engine may then access the selected XML template. See block 134. Although not illustrated in FIG. 6, the form engine may determine whether a newer or updated version of the selected template is available. Each template may have a version and/or a date code. The form engine may communicate with the provider of the template to determine the version and/or date of the template currently available from the template provider, and then compare that version and/or date to the version and/or date of the template currently stored on the device. If an updated template is available, the form engine may request and receive the updated template from the template provider. The form engine would also typically store the updated template so that the updated template is available for future use. Alternatively, the provider of the template may send an updated template to the device when changes are made or a new version is available. This would typically require that the provider of the template be able to store information to track which devices have received which templates, which would typically be tracked from the time each template is first received by a device. The provider would also typically store information to track how updated templates can be sent to each device (e.g., the MMS, email or IP address of the device). As discussed above, the XML template will typically comprise an XML structure, XML interaction logic, and a plurality of forms. The form engine will typically render the forms in an order predefined by the XML interaction logic, beginning with the first form in the predefined order. See block 136. As discussed above, each form may provide information to the user, obtain data from the user, or both. As such, the form engine may determine if data is received from the user in response to the rendering of a form. See block 138. If data is received, the form engine may modify the XML structure in a predefined manner using the received data. See block 140. The form engine may then determine from the XML interaction logic whether all of the forms for the XML template have been rendered. See block 142. If there are remaining forms to be rendered, the next form (according to the XML interaction logic) will be rendered. See block 136. As such, blocks 136 through 142 will typically be repeated until all of the forms have been rendered. When all of the forms have been rendered according to the XML interaction logic, all of the data is obtained from the user according to the rendered forms, and all of the modifications to the XML structure have been performed according to the user-provided data, the modified XML structure is the XML document capable of being rendered by the appropriate XML-based application. The XML document may be stored within the device that created the XML document, or may be output to another device. See block 144. The created application-specific XML document may be capable of being accessed by an RSS application, a FLASH application, scalable vector graphics application, a hypertext markup language application, or a mApache application.

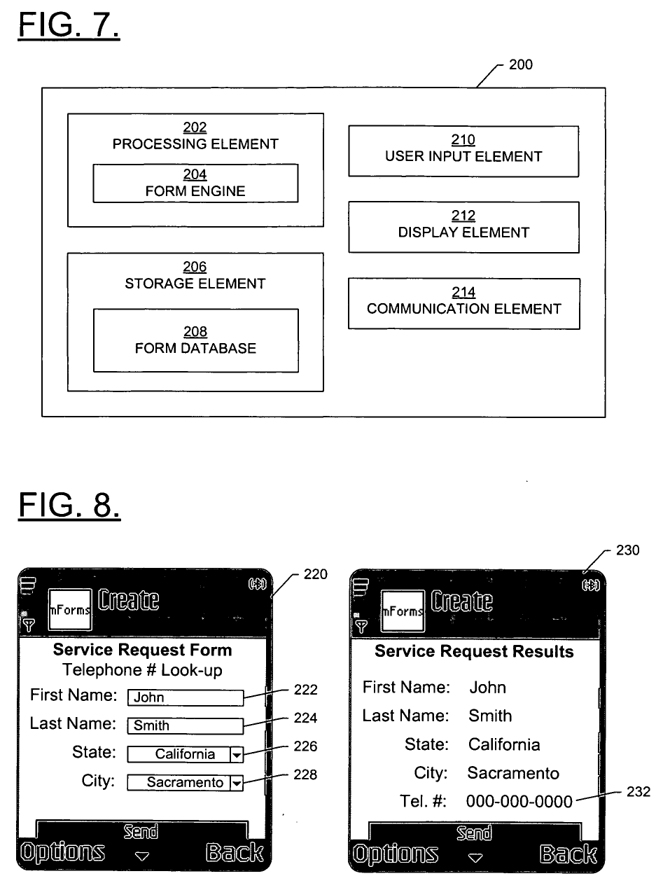

Referring now to FIG. 7, a functional block diagram of a device for requesting a message-based service is illustrated, according to an exemplary embodiment of the invention. The device may be capable of generating a properly formatted service request message based on user input to a service request form and transmitting the service request message to the appropriate service provider. The device 200 may comprise a processing element 202, a storage element 206, a user input element 210, a display element 212, and a communication element 214. The storage element 206 may be capable of storing a plurality of service request forms, such as in a form database 208.

Each service request form may correspond to a single message-based service provided by a single service provider. For example, one form may be used to obtain a telephone number from a directory service provided by one telephone company, while a different form may be used to obtain a telephone number from a directory service provided by a different telephone company. Alternatively, one form may correspond to two or more services and/or two or more service providers, with the format and transmission of the service request message determined by user input or user selection. For example, one form may be used to obtain a telephone number from any one of several different directory services each provided by a different service provider (e.g., different telephone companies). In such a multi-service form, the user may be required to select the preferred or appropriate service provider. One provider may be preferred by the user based on the user's prior experience with that provider, or one provider may be appropriate based on the geographic area covered by each provider. Alternatively, the appropriate service provider may be automatically selected, such as by the form engine 204, based on user input. For example, the appropriate telephone directory service provider may be automatically selected based on the input by the user of the city and state of the owner of the desired telephone number.

Referring now to FIG. 8, a service request form is illustrated, according to an exemplary embodiment of the invention. A service request form typically prompts the user to input the information needed to generate a request for a desired service. The required information will typically vary depending on the information needed by the message-based service. For example, a telephone directory service may require the first name, last name, city, and state of the owner of the desired telephone number, so the form for generating such a service request would typically prompt the user for that information. Similarly, a bus schedule service may require the starting point, the ending point, and the desired day of travel, so the form for generating such a service request would typically prompt the user for that information. In addition to text boxes into which the user may freely enter text, the form may utilize known fixed data entry mechanisms, such as check boxes and drop-down lists, where possible to help ensure the required information is correctly entered. When the data is freely entered, such as in a text box, the forms may use features such as a spell-checker to help ensure that data is correctly entered. In FIG. 8, service request form 220 illustrates a form capable of generating a service request message to a message-based service provider in order to obtain a telephone number. The form 220 prompts the user to enter the First Name, Last Name, City, and State of the owner of the desired telephone number. The form has text boxes 222, 224 for the user to input the First Name and Last Name, respectively. The form also has drop down lists 226, 228 for the user to select the State and City, respectively. In one embodiment, the user may first select a State from the drop down list 226. The drop down list 228 would then typically change to only display the cities within the selected state. The drop down lists help ensure that the City and State information will be input correctly by the user.

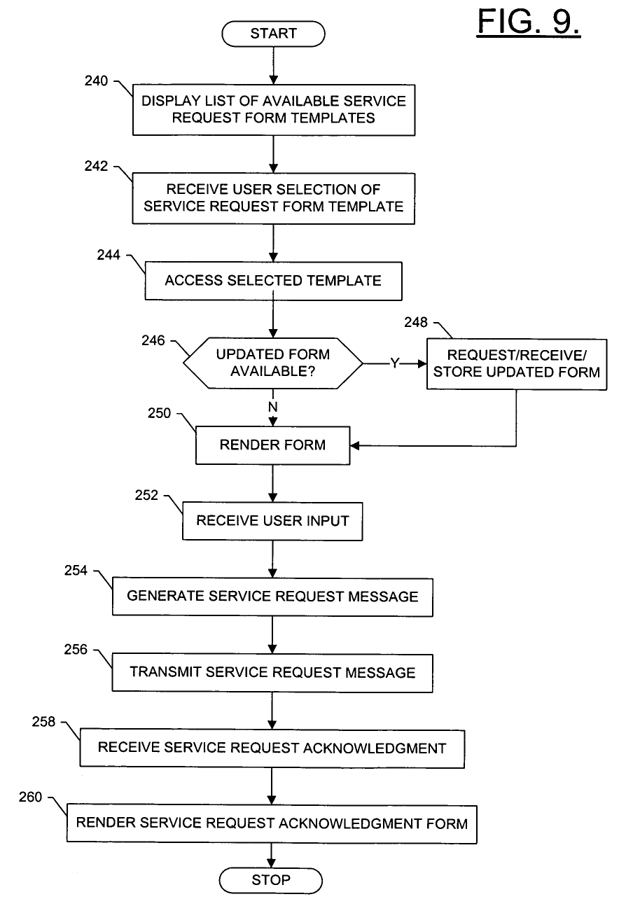

Referring now to FIG. 9, a flowchart of the operation of requesting a message-based service is illustrated, according to an exemplary embodiment of the invention. A list of available service request forms may be displayed, such as by the processing element 202 on the display element 212. See block 240 of FIG. 9. The user may select a desired form from the displayed list, such as by using the user input element 210, and user selection may be received, such as by the processing element 202. See block 242. The selected form would then typically be accessed, such as by the form engine 204 of the processing element. See block 244. The selected form may be accessed from the form database 208. In such an embodiment, the plurality of available forms may be obtained in advance of being used and stored in the device. In an alternative embodiment, a list of available forms may be obtained in advance, but each form would be obtained when selected by the user. The forms may be obtained from each of the different message-based service providers, or from a provider of a communication service used by the device (e.g., a mobile telephone service provider). The forms may be obtained by communicating over a network, using communication element 214, with the provider of the forms.

Once the selected form has been accessed, the form engine may determine whether a newer or updated version of the selected form is available. See block 246. Each form may have a version and/or a date code. The form engine may communicate with the provider of the form to determine the version and/or date of the form currently available from the form provider, and then compare that version and/or date to the version and/or date of the form currently stored on the device. If an updated form is available, the form engine may request and receive the updated form from the form provider. See block 248. The form engine would also typically store the updated form so that the updated form is available for future use. Alternatively, the provider of the form may send an updated form to the device when changes are made or a new version is available. This would typically require that the provider of the form be able to store information to track which devices have received which forms, which would typically be tracked from the time each form is first received by a device. The provider would also typically store information to track how updated forms can be sent to each device (e.g., the MMS, email or IP address of the device).

After it is determined that no updated form is available or after the updated form is received, the form engine will typically render the service request form on the display element. See block 250. As discussed above, the service request form typically prompts the user to input the information needed to generate a request for a desired service, and the user input would be received. See block 252. A properly formatted service request message is then typically generated according to the requirements of the service provider, which are defined by the service request form. See block 254. The service request message may be generated by the processing element 202. In the exemplary service request form illustrated in FIG. 8, the user has input a First Name of “John” into text box 222 and a Last Name of “Smith” into text box 224. The user has also selected the State of “California” using drop down list 226 and the City of “Sacramento” using drop down list 228. The service request message format defined by form 220 (and required by the message-based service provider) may cause a service request message to be generated by the form engine having the format: “Smith, John: Sacramento, Calif.” The user does not need to know or remember the required format, as the required format is defined by the form.

The service request message is then transmitted to the service provider using a predefined communication identifier of the service provider. See block 256. The service request message may conform to at least one of a short messaging service (SMS) protocol, a multimedia messaging service (MMS) protocol, and a messaging queue (MQ) protocol. The predefined communication identifier will typically correspond to the messaging protocol used. For example, if the service request message conforms to the SMS protocol, the communication identifier may be a telephone number. The service request message may be transmitted across one or more networks. For example, the service request message may be transmitted from the device 200 to a mobile telephone network, from the mobile telephone network to the Internet, and from the Internet to the service provider.

When the message-based service provider receives the service request message, the provider will typically perform the action defined by the message. The provider will typically send a return message back to the user. The return message may be a service acknowledgment message, in which the provider is acknowledging successful receipt of the service request message. Alternatively, the return message may be a service result message, in which the provider is sending requested information to the user. For example, if the service request message requested a telephone number, the service result message would typically provide the requested telephone number. The return message (either acknowledgment or result message) may be received by the device 200. See block 258. A service acknowledgment form or a service result form may be rendered by the form engine to display the data from the return message. See block 260. Service result form 230 in FIG. 8 is an illustration of the display of results from a service request message. In form 230, the telephone number 232 provided by the service provider is displayed. In one embodiment of the invention, the service request message may be a subscription request message. In such an embodiment, the service provider may send return messages on a repeated or periodic basis (e.g., daily or weekly) or every time a specified event occurs. The service provider may continue to send return messages until the user sends a service request message requesting termination of the subscription. For example, a service request message may be sent to subscribe to a service that provides information regarding sporting events. In such an example, service result messages may be sent when a predefined sports team begins playing a match, when goals are scored during the match, and when the match ends.

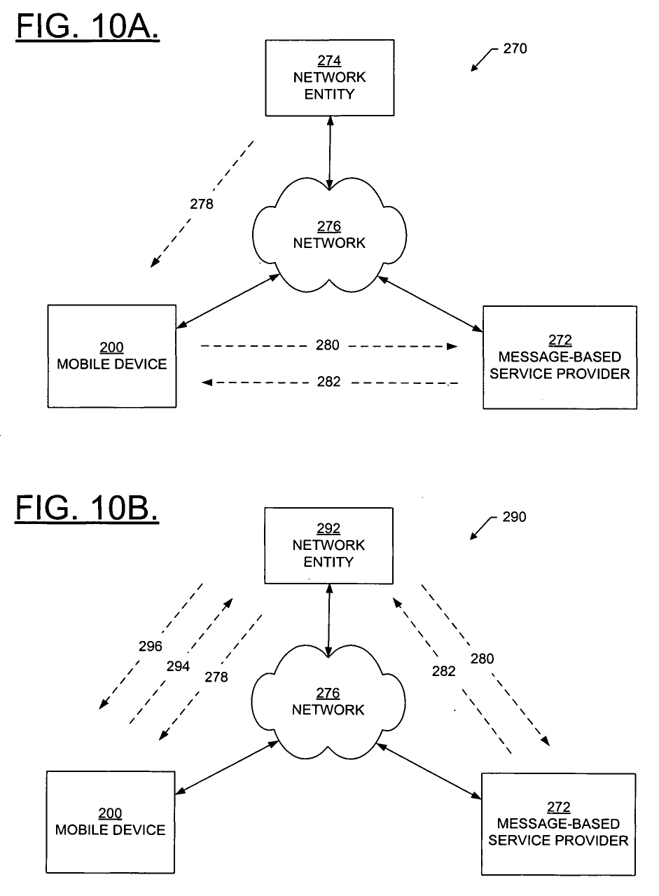

Referring now to FIG. 10A, a functional block diagram of a system 270 for requesting a message-based service is illustrated, according to an exemplary embodiment of the invention. In the embodiment illustrated in FIG. 10A, the mobile device 200 receives the plurality of service request forms from a network entity 274 via network 276, as illustrated by line 278. As discussed above, the network entity may be a communication service provider, such as a mobile telephone service provider. In this embodiment, the service request message is generated in the mobile device 200 and transmitted from the mobile device to the message-based service provider 272 via network 276, as illustrated by line 280. Although illustrated as one network, the transmission of the service request forms and the service request messages may occur across two or more networks. Additionally, the transmission of the service request forms may occur across a different network than the transmission of the service request messages. The service provider typically transmits to the mobile device a service acknowledgment message or a service result message, as illustrated by line 282.

Referring now to FIG. 10B, a functional block diagram of a system 290 for requesting a message-based service is illustrated, according to an alternative exemplary embodiment of the invention. In the embodiment illustrated in FIG. 10B, the mobile device 200 receives the plurality of service request forms from a network entity 292 via network 276, as illustrated by line 278. In this embodiment, however, the mobile device does not generate the service request message. Rather, the mobile device transmits the necessary data defined by the service request form to the network entity 292, as illustrated by line 294. The data is typically transmitted in an XML document. The network entity then generates the appropriately formatted service request message and transmits the service request message to the message-based service provider 272, as illustrated by line 280. In this embodiment, the processing requirements in the mobile device are reduced because the service request message is generated by the network entity. The service provider then typically transmits to the network entity a service acknowledgment message or a service result message, as illustrated by line 282. The data contained in the service acknowledgment/result message may then be transmitted from the network entity to the mobile device, as illustrated by line 296, where the data may be rendered in a service acknowledgment/result form.

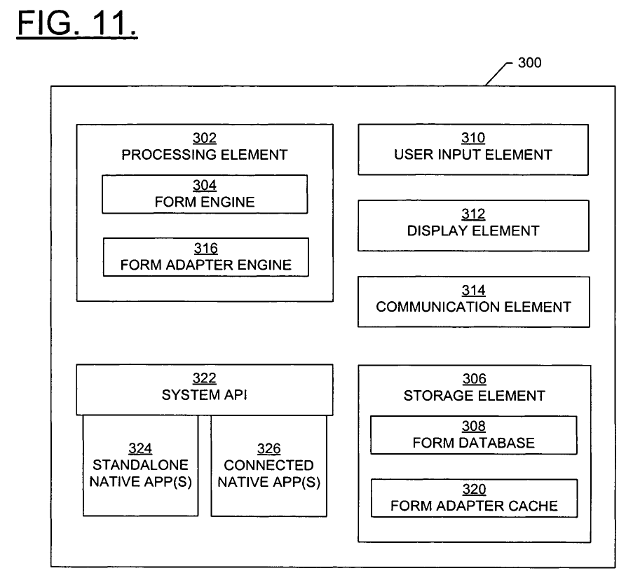

Referring now to FIG. 11, a functional block diagram of a device for interfacing with a native or core software application is illustrated, according to an exemplary embodiment of the invention. The device 300 may comprise a processing element 302, a user input element 310, a display element 312, a communication element 314, and a storage element 306. The user input element may be, for example, an alphanumeric keypad or any other suitable element for receiving user input. The display element may be, for example, an LCD display or any other suitable element for displaying information. The processing element may comprise a form engine 304 and a form adapter engine 316. The storage element may comprise a form database 308 and a form adapter cache 320. As described above, the device 300 is typically able to execute many different native software applications, such as standalone applications 324 and connected applications 326. Examples of standalone applications include word processing applications, spreadsheet applications, clock applications, and camera applications. Examples of connected applications include many different media players, such as FLASH, REAL PLAYER™, and VISUAL RADIO™. Such native applications are typically accessed by the processing element via a system application program interface (API) 322.

A third-party provider of services (“service provider”) may offer services that interface with and utilize one or more native applications to provide new functionality to users of such devices. For example, a device may include a standalone native application that functions as an alarm clock, such that the alarm clock may be set to provide an alert at a specified time. The service provider (or any interested party) may desire to enable new functionality for the alarm clock application, such as the ability to function as an event clock in which an alert may be set to correspond to a particular predefined event. The device may include a connected native application that functions as a media player. Alternatively, the service provider may desire to enable a new feature that combines the functionality of the alarm clock with the functionality of the media player, such that the media player can access and play predefined media (e.g., a web-based news program) at a predefined time. As another example, a service provider may offer a service that interfaces with and utilizes a standalone native application that controls an operating profile of the device on which the native application resides. Many devices, such as mobile phones and PDAs, utilize operating profiles to enable a user to quickly and easily change device settings. For example, the volume and type of user alert (e.g., ringtone or vibrate) provided by the device may be changed via an operating profile (e.g., “outdoor,” “meeting,” or “silent”). The service provider (or any interested party) may desire to enable new functionality for the operating profile application, such as the ability to automatically change the operating profile based on the occurrence of a predefined event. The service provider may, for example, enable new functionality that automatically changes the operating profile of the device corresponding to the user's schedule that is stored in a scheduling application.

The service provider may provide desired new functionality by creating an application-specific and task-specific form. Such a form would typically be an XML document with some hypertext markup language (HTML) code to enable the display of the form. The form may be received by the device via the communication element 314, such as by accessing the service provider's website or by any other suitable technique. Such forms may be stored in the form database 308 to be accessed at a future time. The form engine 304 generally controls the storage, organization, access and execution of forms, the display of information defined by the forms (if any), the receipt of data from the user (if any), the creation of a markup language document, and the provision of such a document to the form adapter engine 316.

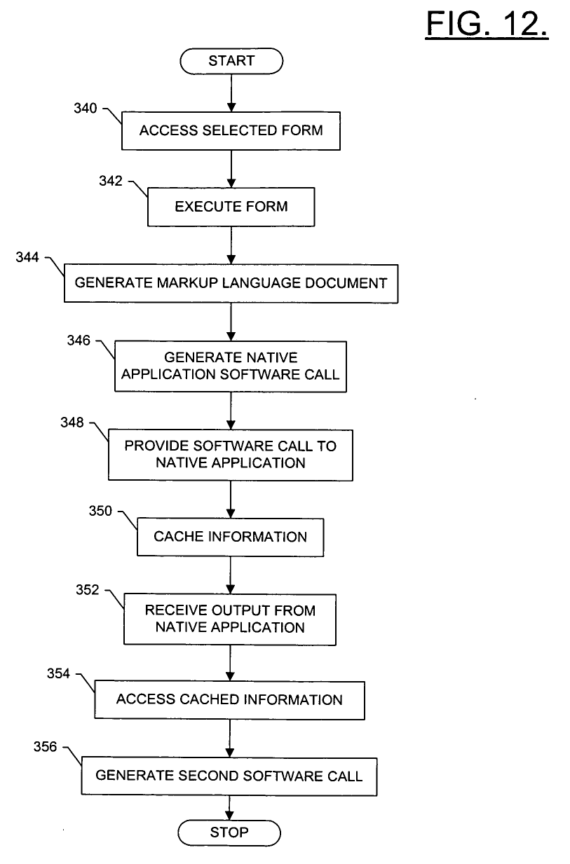

Referring now to FIG. 12, the operation of interfacing with a native software application is illustrated, according to an exemplary embodiment of the invention. A user desiring to implement the added functionality provided by a service provider may select a form previously created by the service provider and stored in the form database. The form engine may provide, for example, a directory of forms from which a user may choose. Based upon the user selection, the form engine 304 will typically access the selected form from the form database. See block 340. Although not illustrated in FIG. 12, the form engine may determine whether a newer or updated version of the selected form is available. Each form may have a version and/or a date code. The form engine may communicate with the provider of the form to determine the version and/or date of the form currently available from the form provider, and then compare that version and/or date to the version and/or date of the form currently stored on the device. If an updated form is available, the form engine may request and receive the updated form from the form provider. The form engine would also typically store the updated form so that the updated form is available for future use. Alternatively, the provider of the form may send an updated form to the device when changes are made or a new version is available. This would typically require that the provider of the form be able to store information to track which devices have received which forms, which would typically be tracked from the time each form is first received by a device. The provider would also typically store information to track how updated forms can be sent to each device (e.g., the MMS, email or IP address of the device). The form engine will then typically execute the accessed form. See block 342. Although not illustrated in FIG. 12, executing the form may cause the form engine to display information on the display element 312 (e.g., a prompt for the user to enter information or make a selection), and/or to receive user input from the user input element 310. The user input may be in many different forms, such as freely entered text or a selection from a predefined list of selectable items using, for example, a drop-down list or a radio button. Either based on the content of the form alone, or based additionally on the received user input, the form engine will then typically create a markup language document, such as an XML document. See block 344. The markup language document generally contains information needed by the form adapter engine 316 to create a software call for the appropriate native application. See block 346. The form adapter engine will typically comprise logic and a library of translations to enable the software call to be created based on the markup language document. The form adapter engine will then typically provide the software call to the appropriate native application (such as standalone native application 324 or connected native application 326), typically via the system API 322. See block 348. This software call invokes existing functionality of the native application which is then used by the form adapter engine to implement the desired new functionality. The form adapter engine may cache information that may be needed at a later time to provide the desired functionality. See block 350. The information may be cached in the form adapter cache 320 for access by the form adapter engine at a later time. After receiving the software call, the native application will typically execute the appropriate action corresponding to the software call, either immediately upon receiving the software call or at a later time if indicated. In some situations, the execution of the appropriate action by the native application in response to the software call may be all that is needed to fully implement the desired added functionality. In other situations, the form adapter engine may perform additional actions, possibly including generating additional software calls for the same or other native applications, to fully implement the desired added functionality. In some of these other situations, the form adapter engine may be prompted to-perform additional actions by receiving an output from the native application. See block 352. As is known in the art, the native application may output information via an Application Interworking protocol. Upon receipt of the output, the form adapter engine may access the cached information in order to use the cached information to perform additional actions. See block 354. Using the cached information, the form adapter engine may generate a second software call, either to the same native application as the first software call or to a different native application. See block 356.

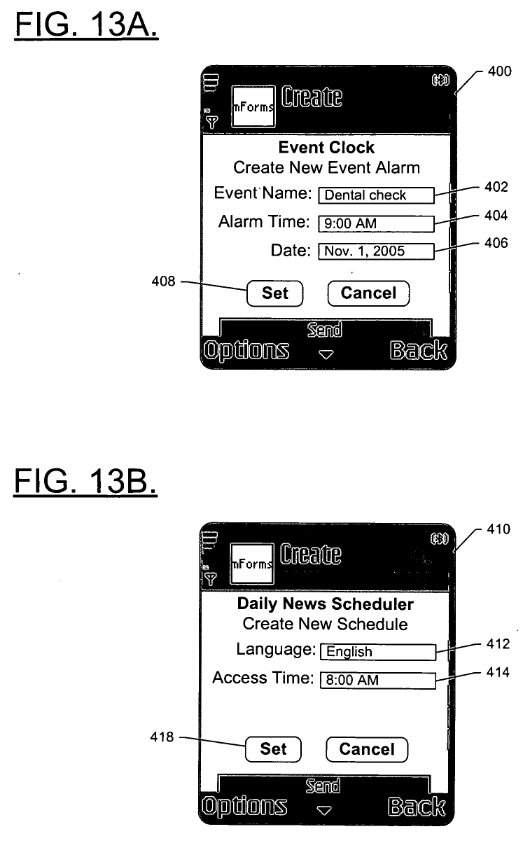

Referring now to FIGS. 13A and 13B, the operation of interfacing with a native software application will be further illustrated using forms capable of implementing new functionality for native software applications, according to exemplary embodiments of the invention. FIG. 13A illustrates a form capable of implementing new functionality using a single native application, specifically the implementation of an event clock using a native alarm clock application. The form 400 of FIG. 13A may be accessed by a user desiring to create an event alarm. This form is application-specific (i.e., specific to the native alarm clock application) and task-specific (i.e., specific to creating an event clock). The form would typically be executed by the form engine, causing the display of the form as illustrated in FIG. 13A. The displayed form prompts the user to input an event name in the data entry field 402, an alarm time in data entry field 404, and an alarm date in data entry field 406. These data entry fields may use freeform text entry fields, drop down lists, radio buttons, calendar selection tools, or any other suitable technique of entering information. The user would typically enter information corresponding to the desired event alarm and then press the “set” button 408. Pressing the set button would typically cause the form engine to generate a markup language document. The markup language document would typically contain sufficient information regarding the desired event alarm to enable the form adapter engine to implement the event alarm. As such, the markup language document would typically define the native application (i.e., the native alarm clock in this example) and contain the information input by the user (i.e., the event name, time, and date). The form adapter engine would then typically generate a software call for the alarm clock application. This software call would be provided to the alarm clock application, such that an alarm would be set in the alarm clock application for 9:00AM on November 1, 2005. In this example, the native alarm clock application is not able to associate an event name with an alarm. The form adapter engine will, therefore, typically cache the event name and other information associated with this event in the form adapter cache. This enables the form adapter engine to associate the event name with the alarm when the alarm alerts and to then display the event name as a further reminder to the user. When the alarm alerts (at 9:00AM on Nov. 1, 2005), the alarm clock application will output this information, typically via the Application Interworking protocol. When the form adapter engine receives this output, the form adapter engine will typically access the cached information to obtain the event name for display to the user.

FIG. 13B illustrates a form capable of implementing new functionality using two native applications, specifically the implementation of a daily news scheduler using a native alarm clock application (a standalone application) and a native media player application (a connected application). The form 410 of FIG. 13B may be accessed by a user desiring to schedule a daily viewing of news accessed from a news website. This form is application-specific (i.e., specific to both the native alarm clock application and the native media player application) and task-specific (i.e., specific to creating a daily scheduled viewing of news). The form would typically be executed by the form engine, causing the display of the form as illustrated in FIG. 13B. The displayed form prompts the user to input a desired language of the news in the data entry field 412 and an access time in data entry field 414. As discussed above, these data entry fields may use freeform text entry fields, drop down lists, radio buttons, calendar selection tools, or any other suitable technique of entering information. For example, data entry field 412 may be particularly suitable to using a drop down list. The user would typically enter information corresponding to the desired daily scheduled news viewing and then press the “set” button 418. Pressing the set button would typically cause the form engine to generate a markup language document. The markup language document would typically contain sufficient information regarding the desired daily scheduled news viewing to enable the form adapter engine to implement the scheduled viewing. As such, the markup language document would typically define the native applications (i.e., the native alarm clock and a specified media player in this example) and contain the information input by the user (i.e., the scheduled time). The form would typically define a language-specific news website for each language selectable by a user, such that the markup language document created by the form engine could define the appropriate news website. In this example, the markup language document would define a predetermined English-language news website. Alternatively, the form 410 could display a predefined list of news websites (e.g., BBC™ or CNN™ ) from which the user could select. In either alternative, the markup language document would typically define a uniform resource locator (URL) for the appropriate news website (e.g., www.bbc.co.uk or www.cnn.com).

The form adapter engine would then typically generate a software call for the alarm clock application. This software call would be provided to the alarm clock application, such that an alarm would be set in the alarm clock application for 8:00AM. In this example, the software call would instruct the native alarm clock application to set a recurring (i.e., daily) alarm. The form adapter engine will typically cache the URL and other information associated with this event in the form adapter cache. When the alarm alerts (at 8:00AM daily), the alarm clock application will output this information, typically via the Application Interworking protocol. When the form adapter engine receives this output, the form adapter engine will typically access the cached information to obtain the URL for the desired news website. The form adapter engine will then typically generate a second native application software call to cause the media player to access the news website defined by the URL. This will enable the user to view the news from that news website using the specified media player.

The forms and templates described in the foregoing embodiments of the invention may be transmitted to a device by any suitable method for transmitting electronic data, including but not limited to SMS, MMS, email, MQ, hypertext transfer protocol (HTTP) download, Bluetooth, or file transfer protocol (FTP).

The method of using a camera image to enter data in a form may be embodied by a computer program product. The method of creating an application-specific XML document may also be embodied by a computer program product. The method of requesting a message-based service may also be embodied by a computer program product. The method of interfacing with a native software application may also be embodied by a computer program product. The computer program product includes a computer-readable storage medium, such as the non-volatile storage medium, and computer-readable program code portions, such as a series of computer instructions, embodied in the computer-readable storage medium. Typically, the computer program is stored by a memory device and executed by an associated processing unit, such as the processing element of the server.

In this regard, FIGS. 2, 6, 9 and 12 are flowcharts of methods and program products according to the invention. It will be understood that each step of the flowchart, and combinations of steps in the flowchart, can be implemented by computer program instructions. These computer program instructions may be loaded onto one or more computers or other programmable apparatus to produce a machine, such that the instructions which execute on the computer or other programmable apparatus create means for implementing the functions specified in the flowchart step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart step(s).

Accordingly, steps of the flowchart support combinations of means for performing the specified functions, combinations of steps for performing the specified functions and program instruction means for performing the specified functions. It will also be understood that each step of the flowchart, and combinations of steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A device for using a camera image to enter data in a form, the device comprising:
a camera element capable of capturing an image;
a display element; and
a processing element capable of displaying a form and displaying at least a portion of the image in an input field of the form, the processing element further capable of extracting a data item from the image and embedding the extracted data item in the input field.

2. The device of claim 1, wherein the processing element is further capable of identifying a data type of the input field and extracting a data item from the image that has a data type corresponding to the data type of the input field.

3. The device of claim 2, wherein the data type is selected from the group comprising text, audio, image, bar code, color, telephone number, uniform resource locator, and email address.

4. The device of claim 2, further comprising a storage element containing a database of data types and corresponding image patterns, wherein the processing element is further capable of comparing the captured image to an image pattern having a data type corresponding to the data type of the input field.

5. The device of claim 1, wherein the processing element is capable of displaying a portion of the image having a size and shape relationship to the image that corresponds to a size and shape relationship between the input field and the form.

6. The device of claim 1, wherein the processing element is further capable of extracting two or more data items from the image and displaying the extracted data items such that a user may select one of the displayed data items, and wherein the processing element is further capable of embedding the selected data item in the input field.

7. The device of claim 1, further comprising:
a storage element; wherein the processing element is further capable of determining if an updated version of the form is available, receiving the available updated version of the form, and storing the received updated version of the form in the storage element such that the processing element displays the updated version of the form.

8. The device of claim 1, further comprising:
a storage element; wherein the processing element is further capable of receiving an updated version of the form that is transmitted from a provider of the form when the provider of the form determines that the updated version of the form is available, and wherein the processing element is further capable of storing the received updated version of the form in the storage element such that the processing element displays the updated version of the form.

9. A method for using a camera image to enter data in a form, the method comprising:
capturing an image;
displaying at least a portion of the image in an input field of the form;
extracting a data item from the image; and
embedding the extracted data item in the input field.

10. The method of claim 9, further comprising:
identifying a data type of the input field;
wherein extracting a data item comprises extracting a data item from the image that has a data type corresponding to the data type of the input field.

11. The method of claim 10, wherein the data type is selected from the group comprising text, audio, image, bar code, color, telephone number, uniform resource locator, and email address.

12. The method of claim 10, further comprising:
accessing a database of data types and corresponding image patterns; and
comparing the captured image to an image pattern having a data type corresponding to the data type of the input field.

13. The method of claim 9, wherein displaying at least a portion of the image comprises displaying a portion of the image having a size and shape relationship to the image that corresponds to a size and shape relationship between the input field and the form.

14. The method of claim 9, further comprising:
extracting two or more data items from the image;
displaying the extracted data items such that a user may select one of the displayed data items; and
embedding the selected data item in the input field.

15. The method of claim 9, further comprising:
determining if an updated version of the form is available;
receiving the available updated version of the form; and
storing the received updated version of the form.

16. The method of claim 9, further comprising:
receiving an updated version of the form that is transmitted from a provider of the form when the provider of the form determines that the updated version of the form is available; and
storing the received updated version of the form.

17. A computer program product for using a camera image to enter data in a form, the computer program product comprising at least one computer-readable storage medium having computer-readable program code portions stored therein, the computer-readable program code portions comprising:
a first executable portion capable of capturing an image;
a second executable portion capable of displaying at least a portion of the image in an input field of the form;
a third executable portion capable of extracting a data item from the image; and
a fourth executable portion capable of embedding the extracted data item in the input field.

18. The computer program product of claim 17, further comprising:
a fifth executable portion capable of identifying a data type of the input field;
wherein the third executable portion extracts a data item by extracting a data item from the image that has a data type corresponding to the data type of the input field.

19. The computer program product of claim 18, wherein the data type is selected from the group comprising text, audio, image, bar code, color, telephone number, uniform resource locator, and email address.

20. The computer program product of claim 18, further comprising:
a sixth executable portion capable of accessing a database of data types and corresponding image patterns; and
a seventh executable portion capable of comparing the captured image to an image pattern having a data type corresponding to the data type of the input field.

21. The computer program product of claim 17, wherein the second executable portion displays at least a portion of the image by displaying a portion of the image having a size and shape relationship to the image that corresponds to a size and shape relationship between the input field and the form.

22. The computer program product of claim 17, further comprising:
a fifth executable portion capable of extracting two or more data items from the image;
a sixth executable portion capable of displaying the extracted data items such that a user may select one of the displayed data items; and
a seventh executable portion capable of embedding the selected data item in the input field.

23. A device for creating an application-specific markup language document, the device comprising:
a display element; and
a processing element capable of accessing a template, the template comprising a predefined markup language structure and a plurality of predefined forms, the processing element further capable of rendering in a predefined order the plurality of predefined forms on the display element, the processing element further capable of receiving data from a user in response to the rendering of at least one of the forms, the processing element further capable of modifying the predefined markup language structure in response to the received data to create the application-specific markup language document.

24. The device of claim 23, wherein the application-specific markup language document is an extensible markup language (XML) document and the predefined markup language structure is a predefined XML structure.

25. The device of claim 23, further comprising:
a storage element capable of storing a plurality of templates, each template comprising a predefined markup language structure and a plurality of predefined forms;
wherein the processing element is further capable of accessing a template in response to a user selection of one of the plurality of stored templates.

26. The device of claim 23, wherein the application-specific markup language document is capable of being accessed by one of an RSS application, a FLASH application, scalable vector graphics application, an extensible hypertext markup language application, and a mApache application.

27. The device of claim 23, further comprising:
a storage element; wherein the processing element is further capable of determining if an updated version of the template is available, receiving the available updated version of the template, and storing the received updated version of the template in the storage element such that the processing element accesses the updated version of the template.

28. The device of claim 23, further comprising:
a storage element; wherein the processing element is further capable of receiving an updated version of the template that is transmitted from a provider of the template when the provider of the template determines that the updated version of the template is available, and wherein the processing element is further capable of storing the received updated version of the template in the storage element such that the processing element accesses the updated version of the template.

29. A method of creating an application-specific markup language document, the method comprising:
accessing a template, the template comprising a predefined markup language structure and a plurality of predefined forms;
rendering in a predefined order the plurality of predefined forms;
receiving data from a user in response to the rendering of at least one of the forms; and
modifying the predefined markup language structure in response to the received data to create the application-specific markup language document.

30. The method of claim 29, wherein the application-specific markup language document is an extensible markup language (XML) document and the predefined markup language structure is a predefined XML structure.

31. The method of claim 29, further comprising:
storing a plurality of templates, each template comprising a predefined markup language structure and a plurality of predefined forms;
wherein accessing a template comprises accessing a template in response to a user selection of one of the plurality of stored templates.

32. The method of claim 29, wherein the application-specific markup language document is capable of being accessed by one of an RSS application, a FLASH application, scalable vector graphics application, an extensible hypertext markup language application, and a mApache application.

33. The method of claim 29, further comprising:
determining if an updated version of the template is available;
receiving the available updated version of the template; and
storing the received updated version of the template.

34. The method of claim 29, further comprising:
receiving an updated version of the template that is transmitted from a provider of the template when the provider of the template determines that the updated version of the template is available; and
storing the received updated version of the template.

35. A device for requesting a message-based service, the device comprising:
a display element; and
a processing element capable of rendering a service request form on the display element, the processing element further capable of receiving at least one user input in response to the service request form, the processing element further capable of generating a service request message incorporating the user input and transmitting the service request message to a predefined service provider using a predefined communication identifier, the service request message conforming to a predefined messaging protocol.

36. The device of claim 35, wherein the processing element is further capable of displaying a list of available service request forms and receiving a user selection of one of the available service request forms, such that the processing element renders the user selected service request form.

37. The device of claim 35, wherein the processing element is further capable of receiving a service acknowledgment message and rendering on the display element a service acknowledgment form corresponding to the service acknowledgment message.

38. The device of claim 35, further comprising:
a storage element; wherein the processing element is further capable of determining if an updated version of the service request form is available, receiving the available updated version of the service request form, and storing the received updated version of the service request form in the storage element such that the processing element renders the updated version of the service request form.

39. The device of claim 35, further comprising:
a storage element; wherein the processing element is further capable of receiving an updated version of the service request form that is transmitted from a provider of the service request form when the provider of the service request form determines that the updated version of the service request form is available, and wherein the processing element is further capable of storing the received updated version of the service request form in the storage element such that the processing element renders the updated version of the service request form.

40. The device of claim 35, wherein the predefined messaging protocol is selected from the group consisting of an email protocol, a short messaging service (SMS) protocol, a multimedia messaging service (MMS) protocol, and a messaging queue (MQ) protocol.

41. A system for requesting a message-based service, the system comprising:
a terminal capable of rendering a service request form on a display element, the terminal further capable of receiving at least one user input in response to the service request form, the terminal further capable of generating a service request message incorporating the user input and transmitting the service request message to a predefined service provider using a predefined communication identifier, the service request message conforming to a predefined messaging protocol; and
a network entity capable of receiving the service request message.

42. The system of claim 41, wherein the terminal is further capable of displaying a list of available service request forms and receiving a user selection of one of the available service request forms, such that the terminal renders the user selected service request form.

43. The system of claim 41, wherein the terminal is further capable of receiving a service acknowledgment message and rendering on the display element a service acknowledgment form corresponding to the service acknowledgment message.

44. The system of claim 41, wherein the terminal is further capable of receiving a service result message and rendering on the display element a service result form corresponding to the service result message.

45. The system of claim 41, wherein the terminal is further capable of determining from the network entity if an updated version of the service request form is available, receiving from the network entity the available updated version of the service request form, and storing the received updated version of the service request form such that the terminal renders the updated version of the service request form.

46. The system of claim 41, wherein the network entity is further capable of determining if an updated version of the service request form is available and transmitting the updated version of the service request form to the terminal, and wherein the terminal is further capable of receiving the updated version of the service request form and storing the received updated version of the service request form such that the terminal renders the updated version of the service request form.

47. A system for requesting a message-based service, the system comprising:
a terminal capable of rendering a service request form on a display element, the terminal further capable of receiving at least one user input in response to the service request form, the terminal further capable of generating a form data message incorporating the user input and transmitting the form data message; and
a network entity capable of receiving the form data message, the network entity further capable of generating a service request message corresponding to the form data message and transmitting the service request message to a predefined service provider using a predefined communication identifier, the service request message conforming to a predefined messaging protocol.

48. The system of claim 47, wherein the terminal is further capable of displaying a list of available service request forms and receiving a user selection of one of the available service request forms, such that the terminal renders the user selected service request form.

49. A method for requesting a message-based service, the method comprising:
rendering a service request form;
receiving at least one user input in response to the service request form;
generating a service request message incorporating the user input; and
transmitting the service request message to a predefined service provider.

50. The method of claim 49, further comprising:
displaying a list of available service request forms; and
receiving a user selection of one of the available service request forms;
wherein rendering the service request form comprises rendering the user selected service request form.

51. The method of claim 49, further comprising:
receiving a service acknowledgment message; and
rendering a service acknowledgment form corresponding to the service acknowledgment message.

52. The method of claim 49, further comprising:
receiving a service result message; and
rendering a service result form corresponding to the service result message.

53. The method of claim 49, further comprising:
determining if an updated version of the service request form is available;
receiving the available updated version of the service request form; and
storing the received updated version of the service request form;
wherein rendering the service request form comprises rendering the updated version of the service request form.

54. The method of claim 49, further comprising:
receiving an updated version of the service request form that is transmitted from a provider of the service request form when the provider of the service request form determines that the updated version of the service request form is available; and
storing the received updated version of the service request form.

55. A device for interfacing with a native software application, the device comprising:
a processing element capable of executing a form, the processing element further capable of generating a markup language document in response to the execution of the form, the processing element further capable of generating a software call for the native software application from at least a portion of the markup language document, the processing element further capable of providing the software call to the native software application.

56. The device of claim 55, wherein the markup language document is generated using an extensible markup language.

57. The device of claim 55, further comprising a user input element; wherein the processing element is further capable of receiving user input from the user input element; wherein the processing element is capable of generating the markup language document further in response to the received user input.

58. The device of claim 55, further comprising a display element; wherein the processing element is further capable of displaying information on the display element in response to the execution of the form.

59. The device of claim 55, further comprising a storage element; wherein the processing element is further capable of storing information in the storage element in response to the execution of the form.

60. The device of claim 59, wherein the processing element is further capable of receiving an output from the native software application, accessing the stored information in response to the received output, and generating a second software call for a second native software application in response to the received output.

61. The device of claim 55, further comprising:
a storage element; wherein the processing element is further capable of determining if an updated version of the form is available, receiving the available updated version of the form, and storing the received updated version of the form in the storage element such that the processing element executes the updated version of the form.

62. The device of claim 55, further comprising:
a storage element; wherein the processing element is further capable of receiving an updated version of the form that is transmitted from a provider of the form when the provider of the form determines that the updated version of the form is available, and wherein the processing element is further capable of storing the received updated version of the form in the storage element such that the processing element executes the updated version of the form.

63. A method of interfacing with a native software application, the method comprising:
executing a form;
generating a markup language document in response to the execution of the form;
generating a software call for the native software application from at least a portion of the markup language document; and
providing the software call to the native software application.

64. The method of claim 63, wherein the markup language document is generated using an extensible markup language.

65. The method of claim 63, further comprising:
receiving user input via a user input element; wherein generating the markup language document is further in response to the received user input.

66. The method of claim 63, further comprising:
displaying information on a display element in response to the execution of the form.

67. The method of claim 63, further comprising:
storing information in a storage element in response to the execution of the form.

68. The method of claim 67, further comprising:
receiving an output from the native software application;
accessing the stored information in response to the received output; and
generating a second software call for a second native software application in response to the received output.

69. The method of claim 63, further comprising:
determining if an updated version of the form is available;
receiving the available updated version of the form; and
storing the received updated version of the form.

70. The method of claim 63, further comprising:
receiving an updated version of the form that is transmitted from a provider of the form when the provider of the form determines that the updated version of the form is available; and
storing the received updated version of the form.
